(19) United States
(12) Patent Application Publication
(10) Pub. No.: US 2010/0187312 A1
(43) Pub. Date: Jul. 29, 2010

(54) GALVANOMETER MOVEMENT WITH TWO ORTHOGONAL AXES OF ROTATION

(76) Inventor: Tohru Takahashi, Saitama (JP)

Correspondence Address: Kaplan Gilman & Pergament LLP, 1480 Route 9 North, Woodbridge, NJ, 07095, US

(21) Appl. No.: 12/527,037

(22) PCT Filed: Feb. 13, 2007
(86) PCT No.: PCT/US07/62027

§ 371 Date: Mar. 12, 2010

(51) Int. Cl. G06K 7/10; G02B 26/08; G02B 26/10

(52) U.S. Cl. 235/462.07; 359/221.2; 359/200.7; 359/199.3; 235/470

(57) ABSTRACT

A two-dimensional galvanometer scanner is disclosed in which two coils are disposed on two adjacent sides of the scanning mirror in order to provide for movement along two orthogonal axes. Preferably, a ball holder and metallic ball are used to implement a ball and socket connection to permit the scanning mirror or other optical element to be moved in the two dimensions.

### TECHNICAL FIELD

This invention relates to optical scanning systems, and more specifically to a system for facilitating a two-dimensional galvanometer in an optical scanning system.

### BACKGROUND OF THE INVENTION

Two-dimensional image capture devices are known in the art. Such devices can be implemented using a matrix of elements constructed from CMOS, CCD, or similar technology. Alternatively, a two-dimensional symbol can be read by scanning a laser beam across plural lines stacked up on top of one another in a second dimension, thereby reading a two-dimensional bar code.

Structures for facilitating a two-dimensional scanner exist in the prior art. However, each of these structures suffers from one or more drawbacks. FIG. 1, for example, discloses a typical prior art arrangement in which two mirrors 102 and 101 are used to facilitate a two-dimensional scan. As indicated in FIG. 1, a light source 103 is projected onto a first mirror 102, which is used to convey the light beam to a second mirror 101. By independently oscillating the mirrors 101 and 102 in different directions, the beam can be made to scan a two dimensional area.

One drawback of such an arrangement, however, is that mirror 101 must be larger than mirror 102 in order to capture the light conveyed by the first mirror 102. Because of the requirement for one mirror to be larger than the other, it is difficult to make a relatively smaller compact design. Additionally, the cost of using two mirrors, and the associated hardware and software to facilitate scanning, tends to increase the cost of the finished product.

In view of the foregoing, there exists a need in the art to provide a compact relatively inexpensive and efficient design for a two axes galvanometer scanner.

### SUMMARY OF THE INVENTION

The foregoing and other problems of the prior art are solved in accordance with the present invention which relates to a galvanometer scanner that may cause scanning in two different, preferably orthogonal, directions. Two coils are used which preferably cause a tilting movement of an optical element in two perpendicular directions. The two coils are each preferably constructed from a yolk and coil to cause movement of a magnet. A scanning mirror or other optical element is mounted on a ball joint which can also move in two independent directions as the fields produced by the two coils vary. As a result, two dimensional movement is achieved.

In addition, a computer controller is equipped with hardware and software to coordinate the fields produced in the two different directions to thus facilitate the movement in the proper amounts and at the proper times in each direction, so that the scan pattern is properly produced. Thus, for example, to scan a two dimensional symbol having plural lines, the controller would be programmed to scan a full line horizontally, and then increment vertically by a small amount equal to the distance between lines. This causes the scanner to scan one line at a time, moving to the next line at the end of each line being scanned.

Other features and advantages of the present invention will be apparent from the following description of an exemplary embodiment of the present invention.

### BRIEF DESCRIPTION OF THE DRAWINGS

FIG. 1 is a conceptual diagram of a prior art galvanometer;

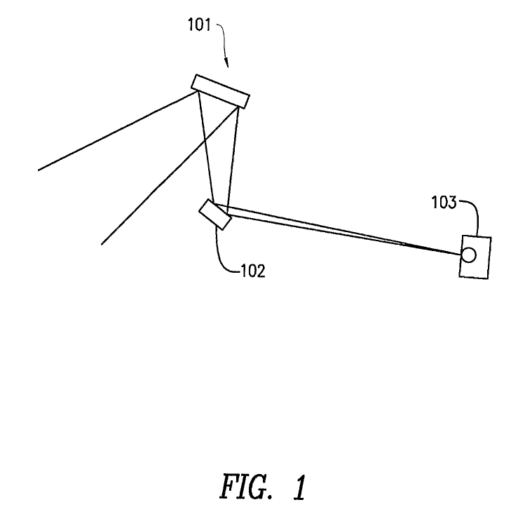

FIG. 2 is a perspective view of an exemplary embodiment of the galvanometer of the present invention; and

FIG. 3 is a cross sectional side of the galvanometer of FIG. 2.

### DETAILED DESCRIPTION OF THE PREFERRED EMBODIMENTS

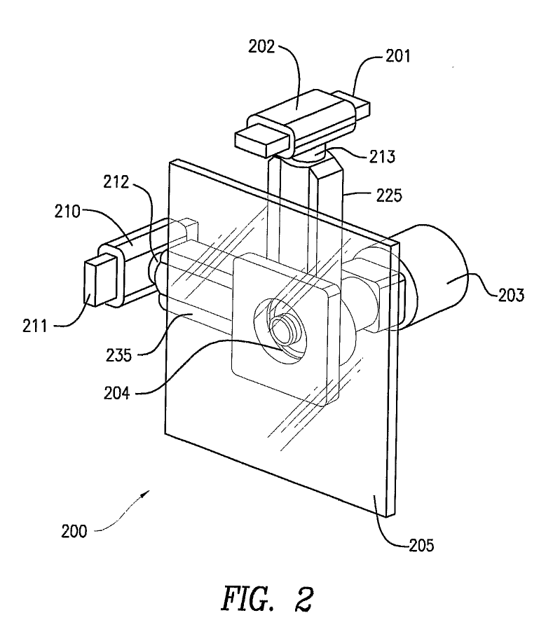

FIG. 2 depicts an exemplary embodiment of the present invention. The arrangement of FIG. 2 includes a coil 202 which surrounds a yolk 201 and which is mounted preferably on a housing or other mounting device (not shown) and connected to a power source. A magnet 213 is connected to an arm 225, which permits movement caused by a varying magnetic field from coil 202 to be transferred into motion of the mirror 205.

An additional coil 210 surrounds a yolk 211 and is utilized to drive a magnet 212. Elements 210, 211, 235 and similar items are as described above, with the exception that these additional elements are disposed in a different dimension as indicated in FIG. 2.

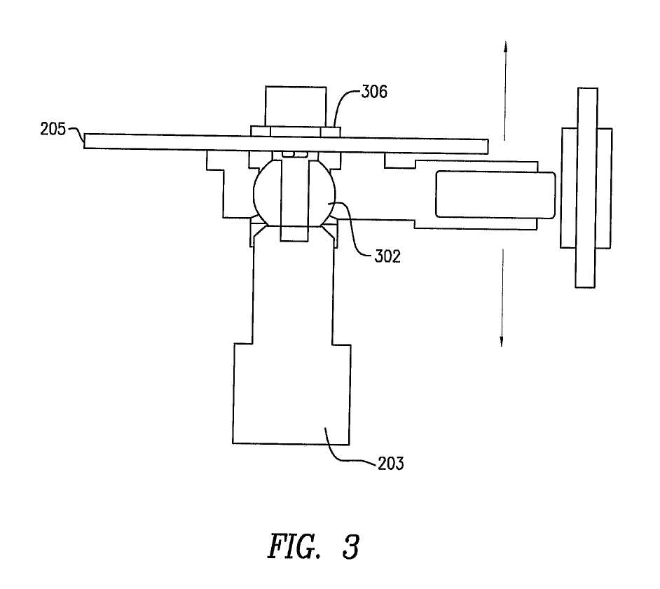

The mirror 205 is mounted to a ball holder 203 with a mounting structure 306 in order to facilitate movement via a preferably metallic ball 302, as shown best in FIG. 3. Not shown in the figures is a light source that is reflected onto mirror 205 to be used for scanning a symbol. Additionally, the mirror 205 in FIG. 2 is artificially shown as transparent only for purposes of the reader viewing the components disposed behind the mirror.

The preferred embodiment will further include software which coordinates the signals that are used to drive coils 210 and 202 in order to permit the prescribed scanning pattern. It is notable that a variety of such scanning patterns may be implemented depending upon the two different signals utilized to drive the coils 210 and 202. By permitting an operator to enter parameter into software, the scanning angles and other characteristics of the scan pattern can be set, and are customizable to the particular device and bar code being read. For example, the operator can set the distance to move up to the next line after each line is scanned, the length of scan for each line, etc. By permitting the scanning patterns of each of the directions to be independently controlled via the signals used to drive the coils 210 and 202, nearly any desired scan pattern can be implemented. This permits and endless variety of symbols to be read, regardless of their shape and configuration.

An important enhancement is to allow the software that controls the scanning to be programmed so that the scanning pattern can be customized to a particular scanning arrangement and symbol. This can be easily selected from a menu structure. One manner in which to simplify the configuration for the system to allow the user to select from a menu of prestored, standardized symbols. Once a selection is made, a database would have prestored the various parameters of that particular symbol so that the drive signals for coils 202 and 210 can be properly set. Additionally, the user may have the option to customize the scan pattern.

As an example, consider a two dimensional, essentially square or rectangular bar code symbol. In one embodiment, the scanning of such a symbol is accomplished by tilting the mirror 205 horizontally to scan each line, and after so scanning each line, tilting the mirror 205 slightly vertically so that a subsequent line is scanned.

FIG. 3 depicts a metallic ball 302 that is held in a structure 306 that permits rotation of the ball, and thus two dimensional movement of the mirror 205, in response to the magnetic fields produced by coils 202 and 210. It is noted however, that other devices that permit two-dimensional movement can also be utilized, as long as they allow the magnets 212 and 213, or other movement means, to independently move so that the mirror 205 can be titled in two orthogonal directions.

Additionally, while the optical element is shown as a mirror 205, the optical element that is moved may be the light source itself, a lens, or other element. These and other enhancements are intended to be covered by the following claims.

1. Apparatus comprising a first driving means and a second driving means disposed along two non-parallel axes, an optical element, and a mounting structure, said optical element being mounted on said mounting structure, said mounting structure being configured to tilt in two mutually exclusive dimensions.

2. The apparatus of claim 1 wherein the optical element is a mirror.

3. The apparatus of claim 1 wherein the optical element is a light emitting device.

4. The apparatus of claim 2 wherein the driving means comprises at least an electrical coil and associated power supply.

5. The apparatus of claim 2 wherein the two mutually exclusive dimensions are orthogonal.

6. The apparatus of claim 1 wherein the first and second driving means are disposed orthogonally to each other.

7. The apparatus of claim 4 further comprising software configurable to permit scanning parameters associated with scanning in at least one direction to be input by a user.

8. The apparatus of claim 1 wherein the mounting structure includes a sphere.

9. A method of facilitating scanning in two directions comprising executing instructions from software that cause at least two different coils to generate magnetic fields in two different directions to cause an optical element to oscillate in two different dimensions.

10. The method of claim 9 wherein the two different directions are orthogonal to each other.

11. The method of claim 9 further comprising providing software that causes a repeated and fixed amount of movement in a first direction after each movement of a second and larger amount in a second direction.

12. The method of claim 11 wherein said software causes a two dimensional symbol to be scanned in line by line.

13. A symbol reading system comprising a ball joint connected to a mounting structure for mounting thereon an optical element that facilitates scanning, said symbol reading system further comprising a light source directed at said optical element, at least two coils, each driven by a signal, and each for causing a field to vary, and a controller that coordinates the timing and magnitude of the signals to cause scanning in two dimensions in a predetermined pattern.

14. The system of claim 13 wherein the optical element is mounted on a ball joint.

15. The system of claim 14 wherein the two coils are disposed nearby adjacent sides of the optical element, and wherein said coils are disposed perpendicular to one another.

16. A computer system for customizing a scan pattern associated with an optical scanner, said system comprising a user interface for permitting a user to select from plural bar code symbols, and software for determining an optimum scan pattern for said selected symbol, said software further comprising steps to set drive parameters for at least two independently driven drive means in response to the user making a selection.

17. The computer system of claim 16 wherein the drive means are electromagnetic coils, and wherein the computer reads data associated with a selected symbol, and uses that data to locate a value indicative of one or more parameters used to drive each coil.

18. The computer system of claim 16 wherein the independently driven drive means is connected to drive a mirror via a ball and socket joint.
